(19) United States
(12) Patent Application Publication
(10) Pub. No.: US 2018/0068342 A1
(43) Pub. Date: Mar. 8, 2018

(54) ADVERTISEMENT ACCESSING SERVER AND ADVERTISEMENT ACCESSING SERVICE METHOD

(71) Applicant: Beijing feiruxu infomation technology Co.,Ltd, Beijing (CN)

(72) Inventor: Tian LUAN, Harbin (CN)

(21) Appl. No.: 15/626,940

(22) Filed: Jun. 19, 2017

(30) Foreign Application Priority Data
Sep. 7, 2016 (CN) 2016108091807

(51) Int. Cl. G06Q 30/02

(52) U.S. Cl. CPC G06Q 30/0242; G06Q 30/0277

(57) ABSTRACT

Disclosed in the present invention is an advertisement accessing server, which comprises a click information receiving unit, an effective click determining unit, a post system determining unit, a direct-link system determining unit, a response transmitting unit, a request transmitting unit, and a response receiving unit. According to embodiments of the present invention, communication of intermediate systems is solved amongst servers, thus enhancing the efficiency of the entire advertisement clicking procedure.

### CROSS-REFERENCE TO RELATED APPLICATIONS

This application claims the priority of the China Patent Application NO. 2016108091807 filed on Sep. 7, 2016 in the China Patent & Trademark Office, the disclosure of which is incorporated herein by reference.

### FIELD OF THE INVENTION

The present invention relates to the field of advertisement, and more particularly, to advertisement accessing servers and advertisement accessing service methods in the is technical field of digital advertisement.

### BACKGROUND

Advertising can be generally classified as brand advertising and performance-based advertising. Performance-based advertising are those based on the advertising effects, where advertisers pay only for measurable results.

In the field of performance-based advertising, advertisements are promoted by advertising agents. During promotion, advertisements are delivered by various Networks and Affiliates, relevant user activities are recorded and delivery effects are appraised, whereupon the advertisers make due payment according to the effects. Generally speaking, an advertiser pays only after a user has finally access to the target web page (in this application, target web page collectively refers to target web page, apple app store, Google play, other online application stores, or the mobile APP) of the advertiser and completed designated actions (such as downloading, installing, registering, purchasing, and so on). Since the promotion towards users involve the advertising agents, the various Networks and Affiliates, advertising fee of the advertisers should also be allocated among them, and different accessing paths of the users might engender different allocation results.

Under certain circumstances, although a user had clicked a promoted advertisement, the target web page of the advertiser was not finally accessed to, thus causing dispute of the allocation and waste of the advertising fee.

### SUMMARY OF THE INVENTION

The present invention is made in view of the aforementioned deficiencies in the prior art, so as to alleviate one or more problems existent in the prior art.

According to one aspect of the present invention, disclosed is an advertisement accessing server, which comprises a click information receiving unit, an effective click determining is unit, a post system determining unit, a direct-link system determining unit, a response transmitting unit, a request transmitting unit, and a response receiving unit.

According to embodiments of the present invention, communication of intermediate systems is directly solved among servers, whereby the efficiency of the entire advertisement clicking procedure is enhanced, better user experience is brought about by quicker network communication, the advertising effect is heightened, and the value of the advertising cost is raised.

### BRIEF DESCRIPTION OF THE DRAWINGS

FIG. 1 is a diagram schematically illustrating the information flow of a known digital advertising system;

FIG. 2 is a diagram schematically illustrating an advertisement accessing server according to an embodiment of the present invention;

FIG. 3 is a diagram schematically illustrating the information flow of a digital advertising system according to an embodiment of the present invention;

FIG. 4 is a diagram schematically illustrating an advertisement accessing service method according to an embodiment of the present invention;

FIG. 5 is a diagram schematically illustrating an advertisement accessing service method according to another embodiment of the present invention;

FIG. 6 is a diagram schematically illustrating an advertisement accessing server according to another embodiment of the present invention; and

FIG. 7 is a block diagram schematically illustrating a computer usable to execute methods is and servers according to embodiments of the present invention.

### DETAILED DESCRIPTION

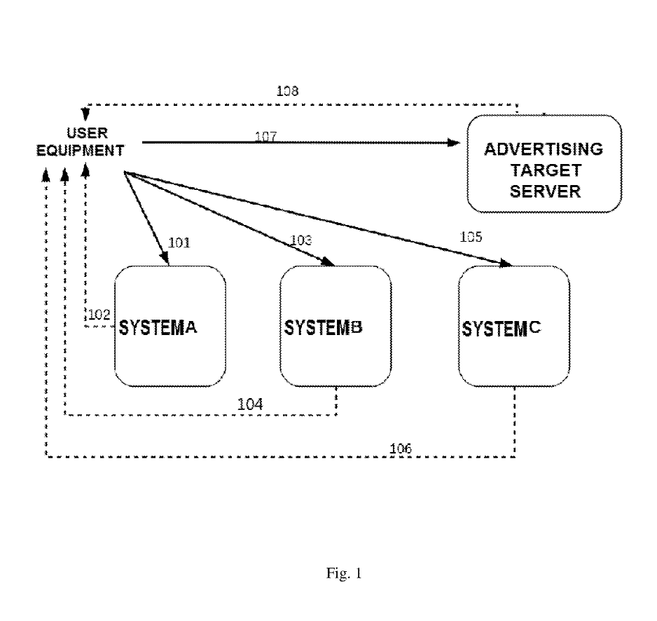

The inventor of the present invention has studied advertising systems known to the inventor. FIG. 1 is diagram schematically illustrating the information flow of a known digital advertising system. Typically, a digital advertising system includes an Affiliate system, a Network system, an agent system, and an advertising target system. In this specification, the servers of the Affiliate system, the Network system and the agent system are not differentiated, and are instead collectively called advertisement accessing servers. The Affiliate system, the Network system and the agent system can also be referred to as advertising broker systems. FIG. 1 shows three advertisement accessing servers that are labeled, respectively, as System A, System B, and System C, indicating that they are controlled by different advertising brokers. The server of the adverting target system stores target web pages, and is hence also referred to as advertising target web page server. Sometimes the final content a client intends to access is not necessarily a web page, but an application to be downloaded, etc., so the web page is mentioned here only by way of example, while the target web page server can also be called an advertising target server.

FIG. 1 shows, in the known system, after a user has clicked an advertisement on the user equipment, a series of network interactions sequences before the user equipment accesses to the target address (for example the advertiser target web page).

In this specification, the user equipment may exemplarily be a mobile phone, an IPAD, a laptop computer, a desktop computer, etc. The mobile phone may be anyone of commercially available mobile phones having an antenna, a memory, a telephone receiver and a telephone transmitter, a keypad, and a display screen capable of displaying advertisements thereon, including candy-bar mobile phones, flip-up mobile phones, etc. The IPAD may be any one being portable and internet-connectible tablet is PC, with or without a keypad and a mouse, and usually with a touch screen, and capable of displaying advertisements.

In the system as shown in FIG. 1, after the user has clicked an advertisement displayed on the user equipment (UE), the UE initiates a request to System A, namely Request 101, according to the ads link. Having received Request 101, System A bases on its own advertisement rules to judge whether the click is an effective click; if it is, System A records the click and its parameters relevant to effect monitoring, and then transmits a redirection response (that is, Response 102) to the UE, for instance HTTP 302 or HTTP 301, which includes a redirected address that is a preset link of System B found according to information in Request 101.

Having received Response 102, the UE initiates a request, namely Request 103, to System B according to the redirected address included in Response 102. After receiving Request 103, System B records the click and its parameters relevant to effect monitoring, and then transmits to the UE a redirection response (that is, Response 104), for instance HTTP 302 or HTTP 301, which includes a redirected address that is a preset link of System C. Having received Response 104, the UE initiates a request, namely Request 105, to System C according to the redirected address included in Response 104.

After receiving Request 105, System C records the click and its parameters relevant to effect monitoring, and then transmits a redirection response, namely Response 106, to the UE, for instance HTTP 302 or HTTP 301, which includes a redirected address that is a preset link of the advertiser target web page found according to information in Request 105.

Having received Response 106, the UE initiates a request, namely Request 107, to the advertiser target web page according to the redirected address included in Response 106. After receiving Request 107, the advertiser target web page returns, to the UE, the target content, namely Response 108.

As the inventor of the present invention found, after the user has clicked an advertisement on the UE, the UE has to sequentially interact with various advertising broker systems such as the Affiliate, the Network and the agent, while the various systems have to record and process the click, and guide the user to the next system, to finally access to the advertiser target web page. As a consequence, as many systems there are between the user and the advertising target address, so many rounds of redirecting network requests will be additionally added, thus increasing the time by which the user access to the advertising target address.

If the user closes the UE window before the user accesses to the final advertising address, it is impossible for the click to arrive at the final address, thus losing the click, and wasting advertising budget. Such losing circumstance is generally expressed as click loss rate. At times when the user network is in bad status, the click loss rate will be even higher.

In view of the above circumstances, the inventor of the present invention made the present invention, whereby it is possible to accelerate access to digital advertisement, so as to shorten the time by which the user accesses to the advertising target, and to lower the click loss rate. As should be noted, the system previously illustrated with reference to FIG. 1 is described as known only for the sake of facilitating comprehension of the present invention, as this does not mean that the system is actually known to persons skilled in the art, and also does not mean that the inventor of the present invention acknowledges that the system is known to persons skilled in the art.

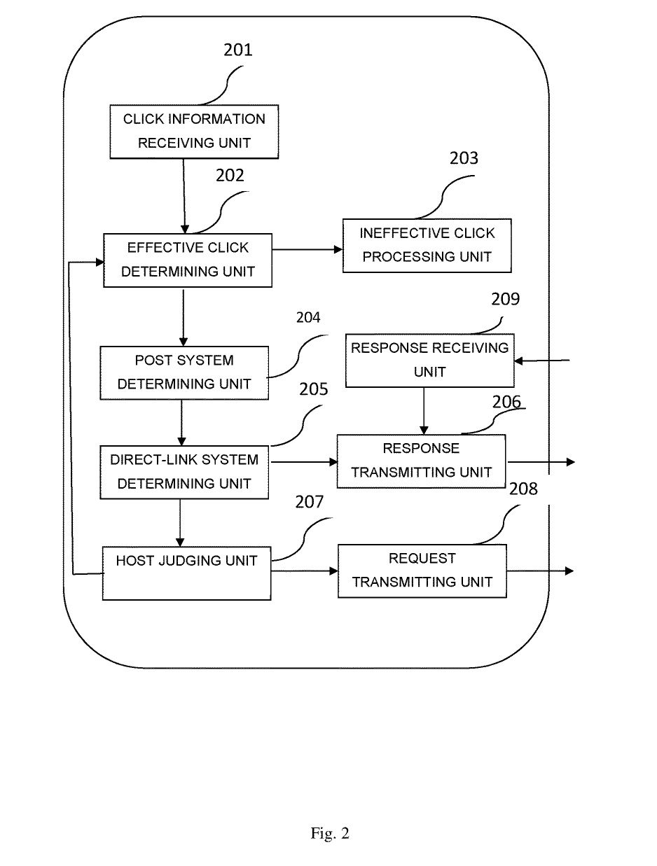

FIG. 2 is a diagram schematically illustrating an advertisement accessing server according to an embodiment of the present invention. As shown in FIG. 2, the advertisement accessing server according to an embodiment of the present invention includes a click information receiving unit 201, an effective click determining unit 202, an ineffective click processing unit 203, a post system determining unit 204, a direct-link system determining unit 205, a response transmitting unit 206, a host judging unit 207, a request transmitting unit 208, and a response receiving unit 209.

The click information receiving unit 201 is used to receive click information (hereinafter referred to as “click information”) of an advertisement audience clicking advertisement on a user equipment or a redirected address request from a previous advertisement accessing server. The click information indicates the click. The click information generally includes the region where the click occurs, the specification of the equipment (namely the UE) by which the click occurs, the developer of the web page or application on which the clicked advertisement is exhibited, the URL address of the clicked advertisement, the name and version of the browser used, etc. Since the redirected address request from the previous advertisement accessing server also includes the click information, so the redirected address request from the previous advertisement accessing server is also called click information according to the context.

The effective click determining unit 202 judges, based on prescribed rules and the click information, whether the click is an effective click with respect to the current advertising broker system. For instance, if the click information shows that the specification of the equipment where the click occurs is an Apple 4 mobile phone, while it is preset by effective rules that the Apple mobile phone on which the click occurs must be of version 5S or higher, it will be judged that the click is an ineffective click. When the effective click determining unit 202 has judged that the click is an ineffective click, the ineffective click processing unit 203 takes over to process, for instance, by discarding the information of the ineffective click, returning an ineffective response, or redirecting to a backup address set up by the current system. The backup address is usually another advertising address without request restriction or with less restriction. Additionally, effective click judgment also includes judging whether the click is a real user click, so as to preclude automatic flow of search engine crawlers.

On the other hand, when the effective click determining unit 202 judges that the click is an effective click, the post system determining unit 203 determines the post system (post advertising broker system or advertiser target system) to which the click should be notified. It is possible to judge the post advertising broker system that should be notified is according to the URL address of the clicked advertisement or the type of the equipment where the click occurs. For instance, the same advertisements can be pushed by advertisement broker X onto the APPLE store of an Apple mobile phone, at the same time, these can be pushed by advertisement broker Y onto the application store of an Android mobile phone, and simultaneously pushed by advertisement broker Z onto the computer web page. Thus, the post system determining unit 203 can base on the equipment where the click occurs to determine whether to notify advertisement broker X, advertisement broker Y, or advertisement broker Z. It is also probable that the current system is already the last system of brokers, that is to say, what follows is the advertiser himself/itself.

When the post system determining unit 204 has determined the post system, the direct-link system determining unit 205 determines whether the post system determined by the post system determining unit 204 is a direct-link system, namely another advertisement broker system directly linkable with the current advertisement accessing server. If the post system is a non-direct-link system, the response transmitting unit 206 transmits a redirection response including the address of the non-direct-link system to the UE or the previous advertisement accessing server that transmits click information to the current server.

If the direct-link system determining unit 205 determines that the post system determined by the post system determining unit 204 is a direct-link system, then the host judging unit 207 determines whether the server of the post system resides at the host; if it resides at the host, the post system is set as the current system, and the effective click determining unit 203 determines whether the click received is an effective click with respect to this post system set as the current system. As should be noted, the host in this context stands for a device having the same URL as that of this advertisement accessing server, and these devices may be connected to one another through a local area network or a virtual private network, and it is not necessarily required to physically integrate them on a single device. According to one embodiment of the present invention, when the host part of the URL address of the post system is, or can be finally parsed as, the address serviced by is this advertisement accessing server, namely when the accessing to the post system will be finally received and processed by the current advertisement accessing server, it is considered that the post system resides at the current advertisement accessing server. For instance, the form of the URL address is usually as follows: protocol://hostname[port]/path/[:parameters][?query]#fragment; according to one embodiment of the present invention, as long as the hostname part in the URL address of the post system is consistent with the hostname part of the URL address of the current advertisement accessing server, it is then considered that the post system resides at this current advertisement accessing server. In addition, the URL address can be parsed as an IP address; if this IP address can be parsed as the IP address of this current advertisement accessing server, it is then considered that the post system resides at this current advertisement accessing server.

If the host judging unit 207 determines that the post system does not reside at the host, the request transmitting unit 208 transmits redirected address request information to the server of the post system, namely the post advertisement accessing server. The redirected address request information includes therein the click information received by the host, the post advertisement accessing server regards the redirected address request information as click information, makes the same processing procedure as that made by the host, and finally feeds the URL address of the advertiser target web page received or found in the host back to the host as a response to the redirected address request transmitted by the request transmitting unit of the host.

The response receiving unit 209 of the current advertisement accessing server receives a response transmitted from the post advertisement accessing server, and then the response transmitting unit 206 transmits the response to the UE or the advertisement accessing server from which the click information is received by the current advertisement accessing server.

The host judging unit 207 can be dispensed with according to another embodiment of the present invention; when the direct-link system determining unit 205 determines that the is post system (post advertisement accessing server) determined by the post system determining unit 204 is a direct-link system, the request transmitting unit 208 directly transmits the redirected address request to the post advertisement accessing server.

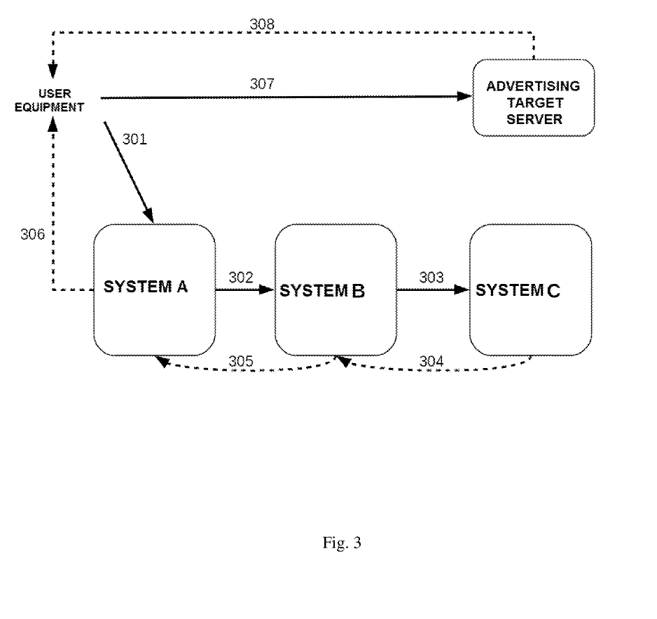

FIG. 3 is a diagram schematically illustrating the information flow of a digital advertising system according to an embodiment of the present invention (in which the host judging unit 207 is not used).

According to one embodiment of the present invention as shown in FIG. 3, after the user has clicked an advertisement displayed on the UE, the UE initiates a request, i.e., Request 301, to System A according to the advertisement link; Request 301 includes the click information of the UE; after receiving Request 301, System A bases on prescribed rules (advertisement setup requirements) to judge whether the user is an effective client; if yes, System A records the click and its other parameters relevant to effect monitoring, searches for a post system B according to the click information, and transmits Request 302 to System B; after receiving Request 302, System B bases on prescribed rules to judge whether the user is an effective client; if yes, System B records the click and its other parameters relevant to effect monitoring, and transmits Request 303 to System C; after receiving the request, System C makes judgment similar to those made by Systems A and B, and returns the target address (by Response 304) to System B since System C is the last advertising broker, whereupon System B returns the target address to System A (by Response 305); finally, System A returns Redirection response 306 to the UE, and UE Request 307 is directed to the advertising target address, so that the advertiser can return, to the UE, the target content, i.e., Response 308.

Although only three advertisement accessing servers are shown in FIG. 3, it should be clear to persons skilled in the art that the advertising system according to the present invention is not restricted as to the number of advertisement accessing servers.

According to embodiments of the present invention, the UE directly communicates with System A and the advertising target server, and does not communicate with intermediate is Systems B and C. Redirect logics of the intermediate systems are replaced by direct communication amongst Systems A, B and C. When the user clicks an advertisement displayed, the servers of the various systems directly communicate with one another, without the UE having to sequentially make redirected address requests to the intermediate systems, instead, the user is directly redirected to the final advertising target address. The internet link of the UE will be restricted by the last kilometer of the network, or restricted by the bandwidth. Conversely, servers are essentially located at the backbone network, and there are also few network paths and nodes through which their mutual communications pass. Consequently, relative to network channels between UEs and servers, network channels among servers are advantageous in terms of both transmission speed and response time. Therefore, by applying the embodiments of the present invention, it is made possible to enhance advertising access speed, optimize user experiences, lower click loss rate, and enhance advertising effects. Particularly in the case of digital advertising promotion where relatively many channels are required, the effects are even more prominent.

As should be noted, although many advantages of the embodiments of the present invention are described in this paper, this does not necessarily mean that the various embodiments realizing the present invention should possess all these advantages, as it is possible to possess some of these advantages. For instance, the last system in the direct-link systems, System C for example, may not be able to return the address of the advertising target system, as it would be better for communication to be carried out amongst the direct-link systems than for communication to be carried out amongst UE and the servers of the respective direct-link systems.

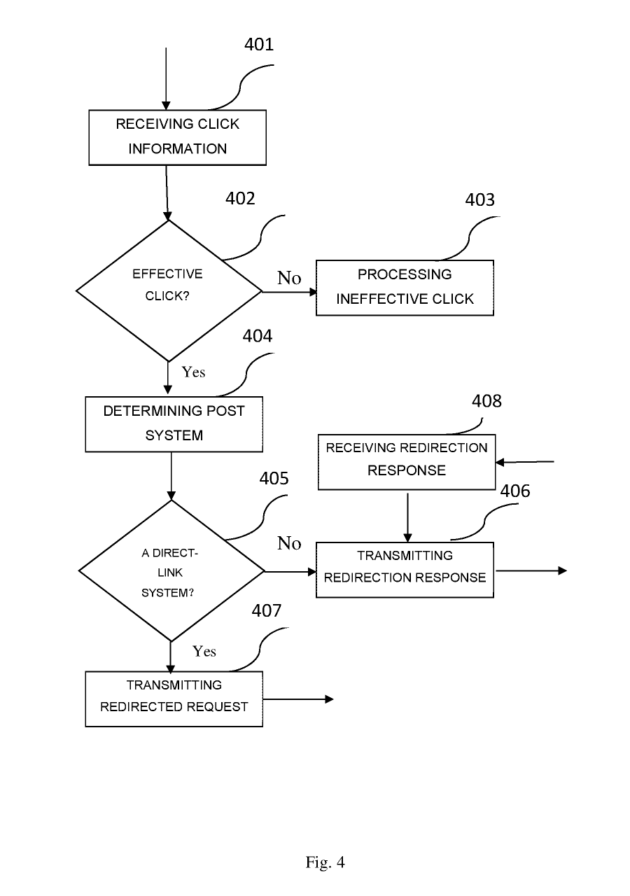

FIG. 4 is a diagram schematically illustrating an advertisement accessing service method according to an embodiment of the present invention. As shown in FIG. 4, first in Step 401 click information on a click of advertisement by an advertisement audience on a UE, or a redirected address request from a previous advertisement accessing server is received. The click information is as previously described, so no repetition is made here.

Then in Step 402 prescribed rules and the click information are based on to judge whether the click is an effective click with respect to a current advertising broker system. When it is judged that the click is an ineffective click, the ineffective click is processed in Step 403, for instance, by discarding the information of the ineffective click, or returning an ineffective response, or transmitting the click information to a backup address set up by the current system.

On the other hand, when it is judged in Step 402 that the click is an effective click, the post broker system to which the click should be notified is determined in Step 404.

When the post system is determined in Step 404, it is determined in Step 405 whether the determined post system is a direct-link system or not. If the post system is not a direct-link system (that is, the post system is a non-direct-link system), a redirection response including the address of the non-direct-link system is transmitted in Step 406 to the UE or to the previous advertisement accessing server from which the click information is received by the current advertising broker system.

If it is determined in Step 405 that the post system is a direct-link system, a redirected address request is transmitted in Step 407 to the server of the post system, i.e., the post advertisement accessing server. A redirection response is then received in Step 408 from the post advertisement accessing server, and the redirection response is transmitted back in Step 406 to the UE or the previous advertisement accessing server that transmits the click information to the host, and then the process ends.

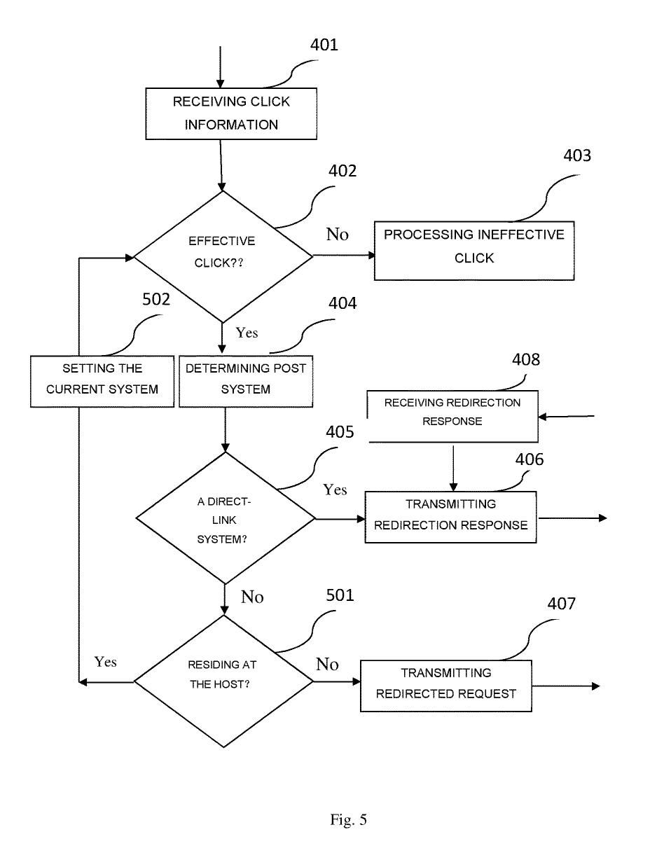

FIG. 5 is a diagram schematically illustrating an advertisement accessing service method according to an embodiment of the present invention. As shown in FIG. 5, Steps 501 and 502 are added to the processing flow of the method shown in FIG. 5 as compared with the processing flow of the method shown in FIG. 4. Steps identical with those in the processing flow of the method shown in FIG. 4 are indicated by the same reference numbers, and the explanations thereof are not repeated in this context—refer to the is explanations made with reference to FIG. 4.

As shown in FIG. 5, when it is determined in Step 405 that the post system is a direct-link system, it is determined in Step 501 whether the server of the post system resides at the host; if yes, the post system is set in Step 502 as the current system, it is then determined in Step 402 whether the click is an effective click with respect to the post system, and the following steps are repeated. As should be noted, the host in this context stands for a device having the same URL address or IP address as the host, and these devices may be connected to one another through a local area network or a virtual private network, as it is not necessarily required to physically integrate them on a single device.

If it is determined in Step 502 that the post system does not reside at the host, redirected address request information is transmitted in Step 407 to the server of the post system, i.e., the post advertisement accessing server.

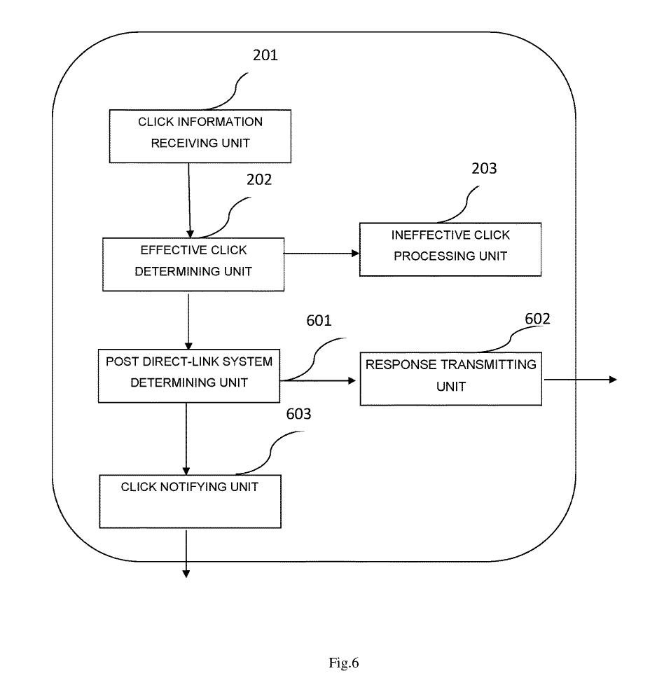

FIG. 6 is a diagram schematically illustrating an advertisement accessing server according to another embodiment of the present invention. As shown in FIG. 6, the advertisement accessing server according to an embodiment of the present invention includes a click information receiving unit, an effective click determining unit, an ineffective click processing unit, a post direct-link system determining unit, a response transmitting unit, and a click notifying unit.

The functions of the click information receiving unit, the effective click determining unit and the ineffective click processing unit are the same as the functions of the corresponding units shown with reference to FIG. 2, so these are not repeated here.

After the effective click determining unit has determined that the click is an effective click, the post direct-link system determining unit 601 determines all post direct-link systems to which the click should be notified, namely systems directly linkable with the current advertising broker system, and obtains the addresses of the last post direct-link systems; the response transmitting unit 602 transmits a redirection response including the address is of the last post direct-link system to the UE or the previous advertisement accessing server that transmits the click information to the current advertisement accessing server, and the click notifying unit transmits the click information to all the post direct-link systems determined by the post system determining unit, so as to facilitate these post direct-link systems recording clicks, and to make it possible to correctly match a certain click during the following conversion process (which can be done by any method known to a skilled person in the art).

Corresponding to the system shown in FIG. 6, the present invention also discloses an advertisement accessing service method, which is used at an advertisement accessing server, and includes receiving click information on a click on an advertisement done by an advertisement audience on a user equipment, or a redirected address request including click information from a previous advertisement accessing server; basing on the click information to judge whether the click indicated by the click information is an effective click with respect to a current advertising broker system; determining all post direct-link systems, namely systems directly linkable to the current advertising broker system, to which the click should be notified, when the click has been judged as an effective click; transmitting a redirection response including the address of the last post direct-link system to the user equipment that transmits click information to the current advertisement accessing server or the previous advertisement accessing server; and transmitting the click information to all the post direct-link systems determined in the step of determining post direct-link systems, so that these post direct-link systems can correctly match a certain click during conversion process.

The above description about the advertisement accessing server device can be used to comprehend the method, while the above description about the method can also be used to comprehend the advertisement accessing server device.

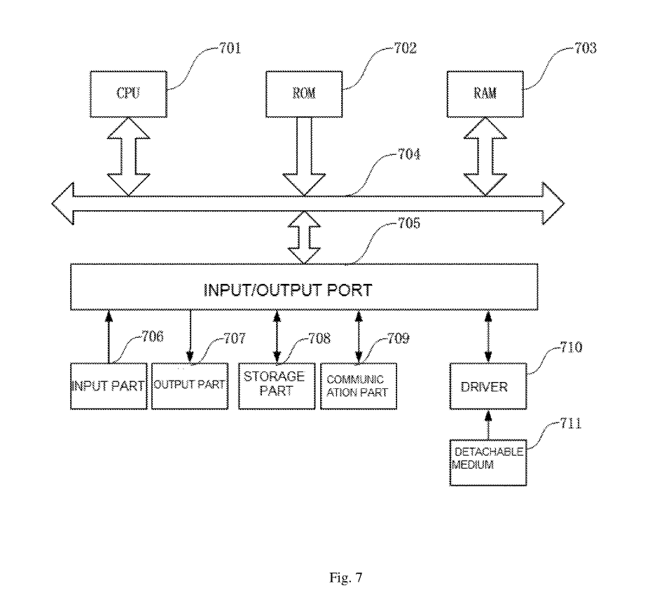

The various constituent modules, units and subunits in the aforementioned server device can be configured through software, firmware, or a combination thereof. Specific means or modes that can be employed for the configuration are well known to persons skilled in is the art, so they are not redundantly described here. The various constituents can be realized through hardware, for instance a field programmable gate array, and can also be realized through a programmed processor. In the case of realization through software or firmware, programs of the software are installed from storage media or network to a computer (such as the general computer 700 shown in FIG. 7) having a dedicated hardware structure, and the computer, once installed with various programs, can execute various functions.

FIG. 7 is a block diagram schematically illustrating a computer usable to execute methods and servers according to embodiments of the present invention.

In FIG. 7, the central processing unit (CPU) 701 executes various processes in accordance with programs stored in the read only memory (ROM) 702 or programs loaded from the storage part 708 to the random access memory (RAM) 703. In RAM 703 are also stored data on demand required for CPU 701 to execute various processes. CPU 701, ROM 702 and RAM 703 are connected to one another via bus 704. Input/output port 705 is also connected to bus 704.

The following constituents are connected to input/output port 705: input part 706 (including keypad, mouse, etc.), output part 707 (including display, such as cathode-ray tube (CRT) and liquid crystal display (LCD) etc., and speaker, etc.), storage part 708 (including hard disk, etc.), and communication part 709 (including network interface card, such as LAN card, and modem, etc.). Communication part 709 executes communication processes via network such as the internet. As required, driver 710 can also be connected to input/output port 705. Detachable medium 711, such as a magnetic disk, an optical disk, an opto-magnetic disk, a semiconductor memory, etc. can be installed on demand onto driver 710, so that computer programs read therefrom are installed into storage part 708 on demand.

In the case of realizing the various processes of the aforementioned methods through software, programs constituting the software are installed from network such as the internet or storage media such as detachable medium 711.

As shown in FIG. 7, the detachable medium 711 stores programs and can be detached from computer and distributes program to users. The storage media is not limited to this. The storage media may be the ROM 702, hard disk included in storage part 708. They can be distributed to used together with the device that includes them.

The present invention also proposes a program product storing machine-readable instruction codes. The instruction codes are read by machine and, once executed, can execute the methods according to the aforementioned embodiments of the present invention.

Correspondingly, storage medium used for loading the aforementioned program product storing machine-readable instruction codes is also disclosed in the present invention. The storage medium includes, but is not limited to, a floppy disk, an optical disk, an opto-magnetic disk, a memory card, a memory stick, etc.

1. An advertisement accessing server, comprising: a click information receiving unit, an effective click determining unit, a post system determining unit, a direct-link system determining unit, a response transmitting unit, a request transmitting unit, and a response receiving unit, wherein:
the click information receiving unit receives click information indicating a click of advertisement on a user equipment by an advertisement audience, or a redirected address request including click information from a previous advertisement accessing server;
the effective click determining unit bases on the click information to judge whether the click is an effective click with respect to a current advertising broker system;
the post system determining unit determines the post system to which the click should be notified when the effective click determining unit has judged that the click is an effective click;
the direct-link system determining unit determines whether the post system determined by the post system determining unit is a direct-link system, namely a system directly linkable to the current advertising broker system;
the response transmitting unit transmits, when the post system has been determined as a non-direct-link system, a redirection response including the address of the non-direct-link system to the user equipment that transmits click information to this advertisement accessing server or the previous advertisement accessing server;
the request transmitting unit transmits, when the post system has been determined as a direct-link system, redirected address request information to a server of the post system, namely a post advertisement accessing server; and
the response receiving unit receives a response, transmitted from the post advertisement accessing server, to the redirected address request information transmitted by the request transmitting unit, and the response transmitting unit transmits the response to the user equipment or the previous advertisement accessing server from which the click information is received by this advertisement accessing server.

2. The advertisement accessing server according to claim 1, further comprising an ineffective click processing unit, which, when the effective click determining unit has based on the click information to have judged that the click is an ineffective click, processes the ineffective click.

3. The advertisement accessing server according to claim 1, further comprising a host judging unit, wherein, when the direct-link system determining unit has determined that the post system is a direct-link system, the host judging unit determines whether the server of the post system resides at this advertisement accessing server, and, if so, sets the post system as the current advertising broker system; the effective click determining unit determines whether the click is an effective click with respect to the post system set as the current advertising broker system, the post system determining unit determines the post system to which the click should be notified when the click is an effective click, the direct-link system determining unit determines whether the post system is a direct-link system, and the request transmitting unit transmits redirected address request information to the server of the post system when the post system has been determined as a direct-link system; the response receiving unit receives a response to the redirected address request information transmitted from the post advertisement accessing server, and the response transmitting unit transmits the response to the user equipment or the previous advertisement accessing server.

4. The advertisement accessing server according to claim 3, wherein the post system is considered to reside at this advertisement accessing server when a URL address of the post system is, or can be finally parsed as, the address serviced by this advertisement accessing server, i.e., when the accessing to the post system will be finally received and processed by this advertisement accessing server.

5. An advertisement accessing service method, used at an advertisement accessing server, and comprising the following steps:
a click information receiving step, receiving click information indicating a click of advertisement on a user equipment by an advertisement audience, or a redirected address request including click information from a previous advertisement accessing server;
an effective click determining step, basing on the click information to judge whether the click is an effective click with respect to a current advertising broker system;
is a post system determining step, determining the post system to which a click should be notified when the click has been judged to be an effective click;
a direct-link system determining step, determining whether the post system is a direct-link system;
a redirection response transmitting step, transmitting, when the post system has been determined as a non-direct-link system, a redirection response including the address of the non-direct-link system to the user equipment or the previous advertisement accessing server;
a redirected address request transmitting step, transmitting, when the post system has been determined as a direct-link system, redirected address request information to a server of the post system, namely a post advertisement accessing server; and
a redirected address response receiving step, receiving a response, transmitted from the post advertisement accessing server, to the redirected address request information, and transmitting the response to the user equipment or the previous advertisement accessing server from which the click information is received by this advertisement accessing server.

6. The advertisement accessing service method according to claim 5, further comprising a step of processing an ineffective click when the click is an ineffective click.

7. The advertisement accessing service method according to claim 5, further comprising a this advertisement accessing server judging step, determining whether the server of the post system resides at this advertisement accessing server, if so, setting the post system as the current system, and, with respect to the post system that has been set as the current system, repeating the effective click determining step, the post system determining step, the direct-link determining step, the redirection response transmitting step, and the redirected address request transmitting step,
wherein the redirected address request information is transmitted in the redirected address request transmitting step to a post advertisement accessing server only when the post system has been determined as a direct-link system, and when the server of the post system does not reside at this advertisement accessing server.

8. The advertisement accessing service method according to claim 7, wherein the post system is considered to reside at this advertisement accessing server when a URL address of the post system is, or can be finally parsed as, the address serviced by this advertisement accessing server, i.e., when the accessing to the post system will be finally received and processed by the current advertisement accessing server.

9. A non-transitory computer-readable storage medium storing a program for causing a computer to function as the advertisement accessing server according to claim 1.
